(19) United States
(12) Patent Application Publication
(10) Pub. No.: US 2012/0004761 A1
(43) Pub. Date: Jan. 5, 2012

(54) Depository Unit With User Interaction

(76) Inventor: Tony O. Madruga, Highlands Ranch, CO (US)

(21) Appl. No.: 13/232,809

(22) Filed: Sep. 14, 2011

Related U.S. Application Data
(63) Continuation-in-part of application No. 11/811,787, filed on Jun. 12, 2007.
(60) Provisional application No. 60/814,174, filed on Jun. 16, 2006.

(51) Int. Cl. G06F 7/00; G06Q 30/00

(52) U.S. Cl. 700/214; 705/14.1

(57) ABSTRACT

A depository unit with user interaction is described. In one example, the depository unit operates by receiving data entered by a user, checking the data for satisfaction of an entry condition, allowing access to a drop chute of a secured storage receptacle if the data satisfies the entry condition, determining whether an item is deposited in the drop chute, and providing a reward to the user if an item has been deposited in the drop chute.

### CROSS-REFERENCE TO RELATED APPLICATIONS

The present application claims the priority of provisional application Ser. No. 60/814,174, Entitled “Drug Return Drop”, filed Jun. 16, 2006 and is a continuation-in-part of prior application Ser. No. 11/811,787 entitled “Smart Collection or Depository Unit” filed Jun. 12, 2007.

### BACKGROUND

1. Field

The present description relates to a depository unit for potentially dangerous, hazardous, valuable, or sensitive materials, and, in particular to a depository unit with that interacts with the user.

2. Related Art

Drugs and other medical supplies present significant risks when not disposed of quickly and securely. Expired drugs, for example, cannot be relied upon to have the intended effects, if taken for the intended purpose. Expired or surplus drugs may present a risk of theft or abuse perhaps endangering those in possession and distribution as well as the eventual user. Expired drugs and medications may also present biological and environmental hazards.

Drugs and other medical supplies may be quickly disposed of to avoid these risks. However, some disposal options present additional risks. Many materials must be disposed of in a specific way that is designed to accommodate drugs, chemicals, and other active agents. If, for example, drugs are simply flushed into a sewer system, dumped into a landfill, or conventionally incinerated, a variety of different compounds may be released into the water, ground, or air that may pose a risk to people, crop or animals that live in or near the affected area.

Similarly, there are many other materials or items for which secure disposal or storage may be desired. Some items may be dangerous to others, may be valuable, or may contain or include sensitive or confidential information. Any of these items may present a risk or theft or abuse. In addition in the disposal of such items, it may be desired to keep records that allow the disposal to be recorded or tracked. It may also be desired to provide a record to person who disposes of the item.

Some sensitive or dangerous items may be possessed by individuals who have little incentive to dispose of them properly. As a result, such items may end up where they may be able to contaminate the environment, or fall into the hands of competitors or enemies.

If drugs and other medical materials and supplies are stored for later proper disposal, then they may present an inducement for theft, illegal sale, or other unsafe, illegal, or hazardous events.

### SUMMARY OF THE INVENTION

A depository unit with user interaction is described. In one example, the depository unit operates by receiving data entered by a user, checking the data for satisfaction of an entry condition, allowing access to a drop chute of a secured storage receptacle if the data satisfies the entry condition, determining whether an item is deposited in the drop chute, and providing a reward to the user if an item has been deposited in the drop chute.

### BRIEF DESCRIPTION OF THE DRAWINGS

The invention may be more fully appreciated in connection with the following detailed description taken in conjunction with the accompanying drawings, in which like reference numerals refer to corresponding parts throughout the several views of the drawings, and in which:

FIG. 1 is a perspective view of a smart collection unit according to an embodiment of the invention;

FIG. 2 is a perspective view of the smart collection unit of FIG. 1 with the access door opened according to an embodiment of the invention;

FIG. 3A is a side view partially cut away of the smart collection unit of FIG. 1 showing internal components according to an embodiment of the invention;

FIG. 3B is a perspective view partially cut away of the top portion of a smart collection unit showing sorting holes in the top funnel according to another embodiment of the present invention.

FIG. 4A is a perspective view of the smart collection unit of FIG. 1 partially cut away with the access door opened according to an embodiment of the invention;

FIG. 4B is a perspective view of the bottom floor panel of the smart collection unit of FIG. 1 removed from the smart collection unit according to an embodiment of the invention;

FIG. 5 is a process flow diagram of servicing a smart collection unit according to an embodiment of the present invention; and

FIG. 6 is a process flow diagram of managing collections for a smart collection unit according to an embodiment of the invention.

FIG. 7 is a process flow diagram of providing user interaction in a smart collection unit according to an embodiment of the invention.

FIG. 8 is a process flow diagram of providing user interaction in the form of a survey and reward in a smart collection unit according to an embodiment of the invention.

FIG. 9 is a process flow diagram of providing user interaction in the form of a scanner and a reward in a smart collection unit according to an embodiment of the invention.

FIG. 10 is a process flow diagram of providing user interaction in the form of a card reader and reward in a smart collection unit according to an embodiment of the invention.

FIG. 11 is a diagram of a smart collection unit that provides user interaction in according to an embodiment of the invention.

### DETAILED DESCRIPTION

A secure storage device allows dangerous, valuable, and sensitive material to be safely disposed of locally and then stored locally until they are later picked up by an authorized service or agency. Such a secure storage device may be used to safely collect and store a wide variety of different types of items, such items may include, for example, environmentally sensitive items, such as drugs, sharps, lancets, electronics, CFL's ((compact florescent lamps)), batteries, plastics, etc. Alternatively, the items may contain sensitive information, such as documents, magnetic storage drives, electronic memory, optical discs, bank or payment account cards, membership cards or certificates, etc. Items may be mixed in a single storage device or different storage devices may be provided for different types of items. In one example, the secure storage device may be referred to as a Drug Return Drop (DRD). The DRD may be an unattended drop box that has been designed with a wide range of powerful features. However, the invention is not so limited.

A drop chute may be provided with a unique key-locked door. The door may be unlocked and opened during collection hours and locked at other times to prevent theft and tampering. The locks may be mechanical, such as a combination or key lock, or they may be electronic. The access door may be fitted with an anti-pry lock system and three point lock system. Access to the interior containers may be by use of key-cards, electronic key-pads, RFID (Radio Frequency Identification) tags or a similar device.

For additional security, alarm systems may be provided for the doors, for major assembly points, for mounting systems and for excessive motion. These systems may also be monitored remotely.

The drop chute may have a dual funnel system for added security and a drop chute baffle. The drop chute may also have a sorting ability so that different kind or packages or sizes of packages may be routed to different collection bins.

The collection containers may be designed or configured specifically to accommodate dangerous, valuable, and hazardous materials, for example hazmat or biohazard bags may be used as the collection containers or within the collection containers. The containers may include sealable lids, nestable, labels, and bar codes or RFID tags. A system of bar-coded tags and labels may be used to allow for tracking through the entire chain of custody. This can allow for complete visibility of the containers or items in the containers from the point of collection, to the point of destruction. Tracking may be accomplished using scannable bar codes, RFID tags or similar devices. The container and the storage devices may be fitted with wired or wireless network connections to allow for remote monitoring and access at all times.

A view port may be provided on the storage device or the collection container to allow an operator to determine whether a collection is due. Alternatively, measuring devices may be used to detect the amount that has been collected. The measuring device may measure the height of the collected material in the container, the weight of the container, the density of the container or any of a variety of other parameters. Alternatively, collections may be scheduled based on the time or day of the week and estimated or predicted usage.

As shown in the figures, the storage device may be fitted with adjustable shelves and compartments. Any one or more of the compartments may be made from materials that accommodate special requirements for the deposited items. This may be special anti-corrosive and anti-flammable materials, depending upon the particular items that are to be deposited.

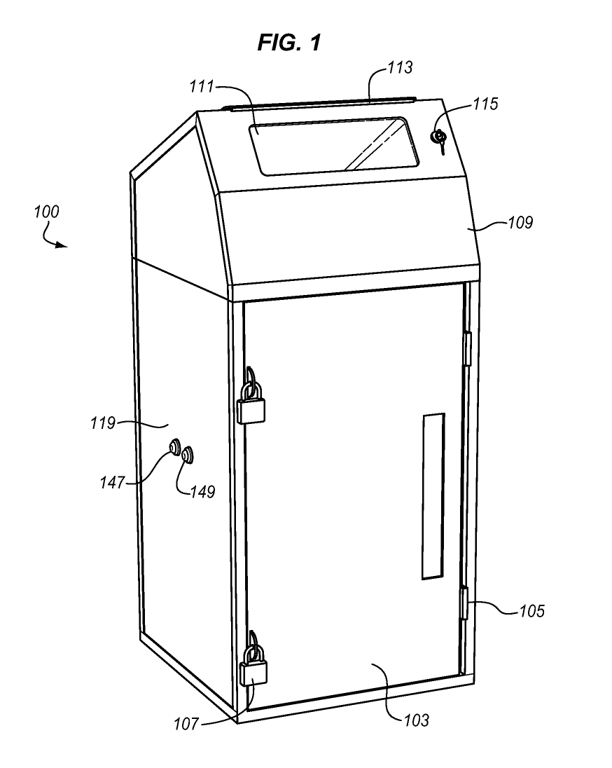

Turning to the drawing figures, FIG. 1 shows a perspective view of a secure deposit receptacle 100 for hazardous or dangerous materials, such as expired, discontinued, or surplus drugs, chemicals or biologically hazardous materials. Such a receptacle may be placed anywhere that such materials need to be disposed of, such as hospitals, doctor's, dentist's, and veterinarian's offices, clinics and laboratories. One application of such a receptacle is as a drug return drop, but there are many other applications as well.

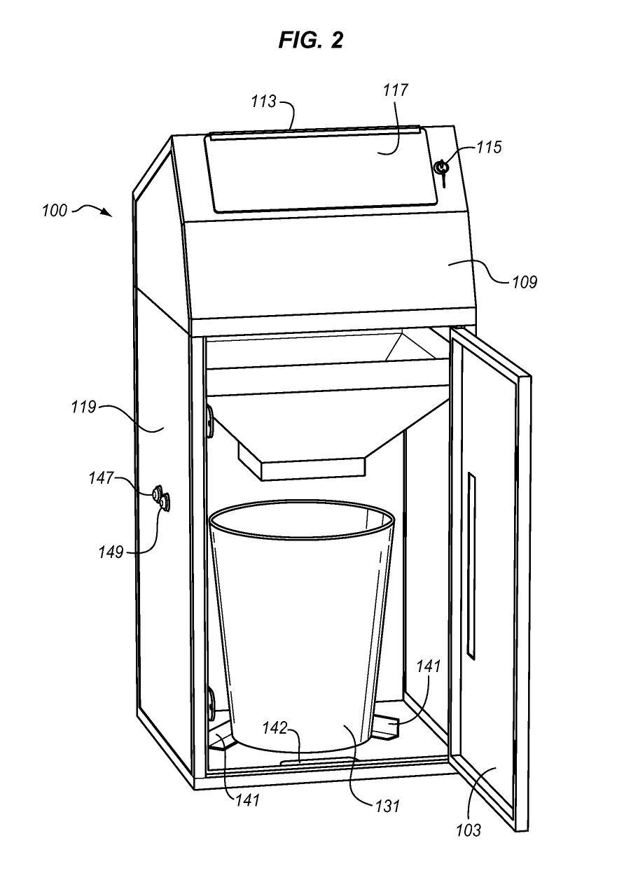

The container 100 has a top drop chute 111 for receiving hazardous or dangerous materials. There is a hinge 113 near the drop chute 111 that is connected to a drop chute cover 117 (see FIG. 2). The cover allows the drop chute to be covered during off hours or if the container is full. The cover not only prevents additional materials from being deposited, but also prevents unauthorized persons from tampering with the receptacle and its contents. The cover may be used to enhance security and to prevent too many items from being deposited in the receptacle.

A lock 115 may be provided for the cover to keep the cover closed when locked. In the example of FIG. 1, a conventional mechanical key lock is shown, however, any of a variety of other types of locks may be used, including electronic and radio controlled locks. A variety of solenoids and actuators may be used to allow the lock to secure the cover when closed.

The receptacle has a top front cover 109 to close out the upper portion of the receptacle and a front access door 103 to control access to the lower portion of the receptacle. The front access door is secured by a hinge 105. In the example of FIG. 1, a piano hinge is shown. The same type of hinge is used for the top cover. Such a hinge is small and difficult to break. The particular choice of hinge may be varied based on the particular application for the receptacle.

The access door is also secured by locks 107. The lock secures the access door to the side walls 119 of the receptacle. In the example of FIG. 1, padlocks are used. By using only mechanical locks, the receptacle may be operated without any source of power by anyone who possesses the appropriate keys. A different key may be used for the cover than for the access door. In this way, a low security operator may be trusted with a key to secure the cover during off hours. The access door key is then not compromised by the low security operator. For the access door, access may be restricted to high security operators, depending on the application.

Turning to FIG. 2, when the front access door 103 is opened, the entire contents of the receptacle may be accessed. In the example of FIG. 2, the receptacle's lower interior contains a removable storage container. In this example, a conventional high density polyethylene (HDPE) 5 gallon (20 liter) bucket 131 with a Linear Low Density Polyethylene (LLDPE) liner 133 is used. These materials are inexpensive, readily available and recyclable. They are also impervious to many hazardous and dangerous materials and inflammable under many circumstances, however a variety of other materials may be used.

Alternatively, only the liner or only the container may be used. The particular choice of container and liner, if any, may be modified to suit any particular application. A lid is also provided in the lower interior of the receptacle so that the container may be removed, closed, sealed with the lid and taken to a disposal, destruction or recycling facility.

The liner may be left in the container or it may be removed so that the deposited items are transported in the liner without removing the container. As an alternative to the liner, a protective coating may be applied to the container or a container may be used without a liner. The liner may allow excess material to be handled without touching the collected items. The liner may be twisted or sealed closed prior to the container lid being secured in place.

Due to the particular choice of container and liner and the construction of the receptacle, the receptacle may be serviced without physically touching doors to open or push buttons. This may be important to avoid any transfer of harmful elements from within the container. The liner contains excess material so that it may also be collected and removed without touching the collected items. The liner may then be twisted or sealed closed prior to the container lid being secured in place.

The container may have labels or markings specific to the type of materials that are likely to be or allowed to be deposited. Different labels or markings may be used for different containers, for different facilities and for different allowable uses. The marking or labels may be machine-readable, or human-readable. Printed identifications, bar codes, RFID tags and other approaches may be used. The labels or markings may be embedded, attached, adhered or within the material matrix of the container itself. A fiber reinforced label that includes or incorporates a bar code, an RFIC tag, or any other similar device may be used.

In one example a multilayer adhesive tag may be used. Such a tag may encapsulate an RFID tag inlay, sealing it from environmental conditions that could have an adverse affect on the performance and life of the RFID tag. A variety of substrates including polyester, polypropylene or polycarbonate may be used. A carrier, usually white, may be used as the upper layer of adhesive and to provide opacity.

The conventional type of bucket displayed may also be fitted with a convenient handle or handles (not shown) for easy removal. The container and the handles may be configured so that the operator is not required to contact the collected or deposited items. While a round plastic bucket is shown, other shapes and materials may be used. In one example a coated square cardboard box may be used.

FIG. 2 also shows the cover 117 in the closed position so that the drop chute is not accessible. In this example, the cover is in the form of a flap attached by a piano hinge 113 to the top of the receptacle. The cover completely covers the drop chute in the closed position and may be opened to fold back over the top of the receptacle. In the open position, it rests completely on the top of the receptacle and allows open, free access to the drop chute. This design offers a benefit in that a person does not need to touch or move any part of the receptacle in order to deposit packages, items, or commodities inside the receptacle.

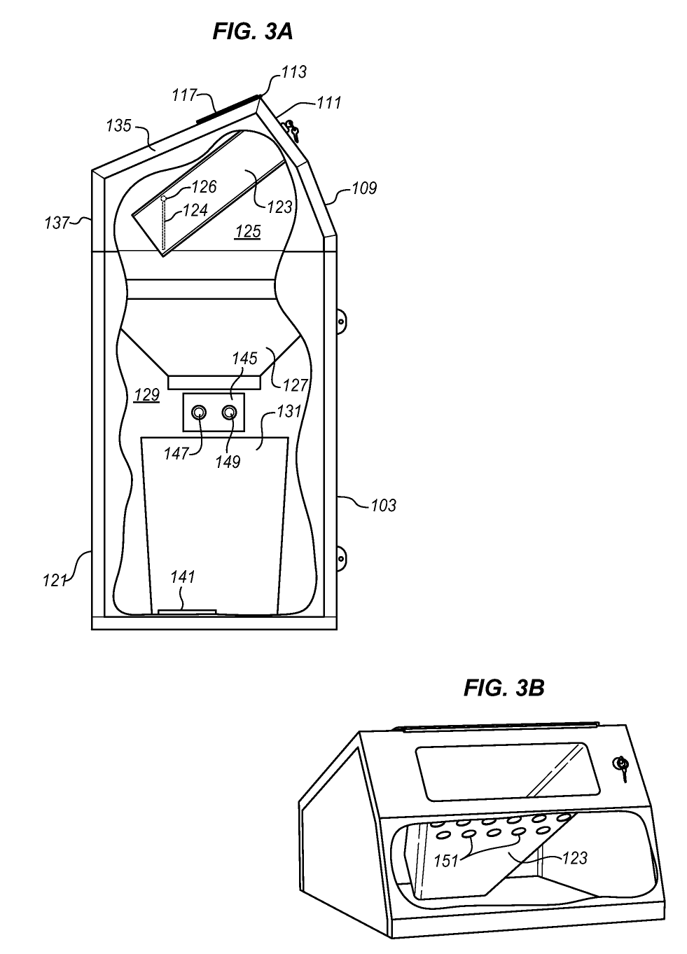

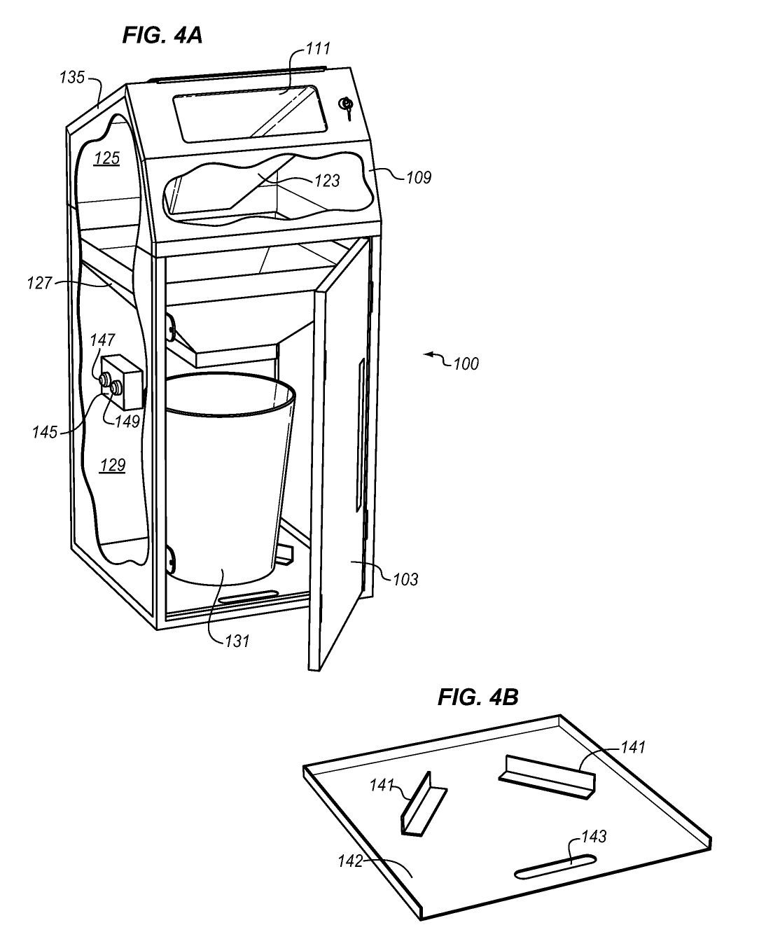

FIG. 3A shows a cross-sectional side view of the receptacle 100. As shown in FIG. 3, the top front cover 109 is folded over the top of the receptacle to expose the drop chute opening. The drop chute opening 111 is formed in this front cover. The drop chute opening is, in this example, formed by a drop chute 123. This drop chute is in the shape of a funnel, as shown more clearly in FIG. 4. It forms the first part of a two-funnel system. The top chute guides deposited materials into the upper interior chamber 124 of the receptacle. The front cover 109 encloses this chamber. The chamber is further enclosed by a top wall 135 and a back wall 137. The cover 117 in FIG. 3 has been folded back to rest flush over the top wall.

The top funnel guides the deposited items into a second bottom funnel 127. The bottom funnel guides the deposited items into a lower interior chamber 129. In the lower chamber, the deposited items are guided by the funnel to land in the container 131. The two funnel system allows the drop chute to be conveniently positioned at a comfortable height at the front of the receptacle. The two funnel system also prevents any access to the container through the drop chute. While the funnels are both shown as completely open, either or both of them may be fitted with baffles that open when an item is deposited and that close otherwise. The baffles may be operated by the weight of a deposited item or, for lightweight items, a separate electrical or hydraulic actuator (not shown) may be used.

In the example of FIG. 3A, a single baffle 124 is mounted inside the first funnel. It is attached to the top of the funnel, at a single pivot point, by a hinge 126. The baffle is held in place by gravity and may also be held in place by a light spring in the hinge. When items traveling down the funnel strike the baffle, the baffle gives to allow the items to pass through to the second funnel 127. On the other hand, it is difficult to remove items from the bottom of the receptacle through the chute 111 due to the obstructing baffle. In addition, as shown in the figure, when closed the baffle extends at a diagonal across the funnel. This limits its motion to one direction. This prevents it the bottom of the baffle from being moved upward toward the drop chute. It will not yield to items moving up the funnel.

The lower interior chamber is enclosed by the access door 103, side walls 119 (cut away in FIG. 3), and a rear wall 121. While the back wall for the lower chamber and the upper chamber are shown as two separate pieces 121, 137, they may be formed as a single piece depending on the application. Similarly the side walls may each be a single piece or there may be an upper and a lower portion.

FIG. 3B shows a perspective view, partially cut away, of the top portion of the receptacle in an alternative form. In the example of FIG. 3B, the top funnel 123 includes sorting holes in the lower surface of the chute. Holes or cut-outs of different sizes are used to sort smaller items from larger items. The lower funnel is then adapted (not shown) so that the smaller items, for example loose pills, that fall through the holes are directed to a different storage bin, than larger items, for example pill bottles, that travel the whole length of the chute.

FIG. 4A shows a partially transparent, perspective view of the receptacle 100. From this view, the funnel shapes are more easily seen. The top funnel 123 is in the form of a chute with a wide opening and sides that taper toward each other. The top and bottom of the top funnel are roughly parallel, however, they may also taper toward each other depending on the application. The top funnel is designed to direct deposited materials to the lower funnel 127. This funnel is in the form of a square at its top with four equally shaped and sized side walls. Each side wall is angled toward the center of the square to form a four-sided funnel. The deposited items, upon entering the lower funnel, are directed toward the rough center of the container 131. Note also that any items that do not directly enter the lower funnel from the top funnel will impinge upon an interior wall of the receptacle and from there be guided by gravity into the lower funnel.

The receptacle may be made of any of a wide range of materials. In one example, the entire structure is made of stamped steel and the interiors of the funnels are coated with a non-slip plastic coating that is resistant to degradation by the deposited materials. However, the funnels may be made of a different durable material, such as polypropylene or another plastic. Alternatively, the entire receptacle may be made of polycarbonate, ABS (Acrylonitrile Butadiene Styrene), or other metals, such as aluminum. The exterior walls are formed of a material that resists unauthorized access to the interior. While the funnels and interior are formed of a material that resists corrosion or degradation caused by the deposited materials.

An additional feature shown in the figures is guide rails 141 that position the collection container in the ideal position to be a collection target below the dual funnel system. In the particular example shown in the Figures, there is a particular there are two orthogonal back rails 141 on the bottom floor 142 of the lower interior chamber to limit how far the container may be pushed into the interior of the receptacle. If desired a front rail (not shown) may be added to further constrain the container. The guide rails are configured based on the particular funnel system and the container. When an operator replaces or empties the container, the container may be restored to the optimum position by placing it between the guide rails and pushing it back until the container comes up against them. The guide rails allow the container to be quickly and reliably positioned inside the container.

FIG. 4B shows the bottom floor in a perspective view separate from the receptacle. This allows the guide rails 141 to be seen more clearly. The particular shape and orientation of the guide rails may be selected to suit the particular container and receptacle. As an alternative, for a rectangular receptacle such as coated cardboard box, two parallel side rails and a perpendicular back guide rail may be used. The illustrated bottom floor 142 also has a handle 143 in the form of an opening. This allows the bottom floor to be grasped and removed. It may then be inverted and replaced in the receptacle upside down. The reversible bottom floor allows different types of guide rails to be provided with the same receptacle. The underside of the bottom floor (not shown) may have no guide rails or a different set of guide rails. This allows the same receptacle to be adapted to different applications.

For additional security, the receptacle may be kept locked at all times and opened only for emptying or other servicing. For even greater security, the receptacle may be securely fastened to the wall, the floor or both. The receptacle may also be fitted with alarms that detect tampering. Tampering may be detected using motion detectors or door sensors. The sensors may be used to activate an audible alarm and may instead or, in addition, be used to notify a central office or security office that the receptacle has been tampered with.

The security features of the illustrated receptacle are provided by a security module 145 mounted inside the receptacle. In the example of FIG. 3, it is mounted in the lower interior chamber for easier servicing. The security module is an optional feature and may take a variety of different forms. It may be battery powered or powered by the mains. If it is battery powered, the battery level may be checked when the container is emptied. It may provide a wireless connection through an integral radio to a service office or it may be adapted for a wired connection through any of a variety of different communication systems. The antenna for the wireless connection may be provided within the module or attached to the interior or exterior of the receptacle. Alternatively, a portion of the housing of the receptacle may be used as the antenna.

The security module may also provide connections for the tampering and motion sensors described above. It may be configured to collect sensor data and then determine whether an alarm event has occurred. The security module is shown as having two indicators 147, 149. These indicators may be provided by LEDs (Light Emitting Diodes), mechanical flags, electroluminescent bulbs or any of a variety of other visible indicators. The first indicator 147 is a security indicator. It may be activated when the receptacle has been tampered with. Depending on the nature of the sensors, different indications may be used to indicate different types of tampering.

The display may also be used to indicate a time to the next service. The second indicator may be a service indicator. It may be activated when the container is full, as detected by level, weight, a timer or any other method as mentioned above. As a simple example, the second indicator may be a service indictor. The second indicator may be illuminated when the container is full. As an alternative, the indicator may be illuminated when the container is 80% full and then made to blink when the container is 90% full. If there is more than one container, then different indicators may be used for the different containers. To allow for this functionality, the security module may be connected to sensors that determine whether the container is full, such as the scales, optical sensors, and timers mentioned above.

The two LEDs are provided as an example only. Different types of displays that are more simple or more complex may be used. A more complex display may be used to indicate a particular type of tampering or different levels of service that are needed. The display may, for example, be graphic or alphanumeric or use combination of lights and icons. The information provided by the display may also be provided to a central office through the network connection or much more information may be provided, so that more or all of the sensed information is available at the central office. Communications with a central office may be used as an alternative or as an addition to the display.

A receptacle, collection, or depository, such as that described above, may be used as a drug return drop, as a collection site for contaminated or biohazardous material, or for any of a variety of other applications. As a drug return drop, it may be located at pharmacies, urgent care centers, hospitals, senior homes, etc. By providing a convenient and secure way to dispose of expired and unwanted drugs, serious effects on wildlife and the environment may be mitigated. As a drug return drop, the receptacle provided above provides important security to prevent the collected drugs from being misused or abused.

In use, a collection unit of the type described herein may be provided for the safe collection or deposit of pharmaceuticals and other dangerous or harmful items. The collection unit may be conveniently located in high traffic or frequently visited locations where pharmaceuticals and other items are distributed. Due to the security features that may be provided for the receptacle, the collection or depository may be left unattended. This is particularly the case when the collection or depository is locked and securely fastened to the wall or the floor. The chute door may be closed at certain hours of the day or night, for example when the pharmacy or clinic is closed, or when there is no one near the receptacle who could determine whether it is being tampered with.

The collection or depository may be used by consumers of pharmaceuticals and other harmful items as a way to dispose of unwanted or expired pharmaceuticals. Customers may bring expired or unnecessary prescriptions to the pharmacy and dispose of them safely when picking up new prescriptions or on other errands.

The collection or depository may be monitored periodically both for the amount collected and for tampering. In the example of FIGS. 1-4, the receptacle has a window on the access door. This window may be placed on either the side wall or the back wall instead. It allows an operator to observe how full the container is. As an alternative, an automatic optical system may periodically observe the height of the collected items and activate an indicator, such as a flashing light, on the receptacle or send a message to a central office when the receptacle is perceived to be full. As another alternative, a scale may be integrated into the floor of the receptacle that weighs the container. When the container reaches a certain weight, then the light may be activated, or the central office be contacted for a pickup. Other monitoring systems may also be used.

In addition to the servicing needs, additional sensors may be used to determine when there is tampering. The access doors, fastening points, assembly points and excessive motion may all be monitored and an alert generated by the security module that can be provided locally or remotely. As an example, a tampering light may be activated or a central office may be contacted.

In use, a collection from the receptacle is scheduled, either based on a predetermined schedule, or based on a determination that the receptacle is full. As mentioned earlier, the window in the access door may be used to determine whether the receptacle is full, the indicator of the security module may be used, or either in addition or as an alternative, the receptacle may report directly to the central office. If a local indicator shows the receptacle to be full, then a responsible person may be designated to monitor the receptacle and call a number or send a report when the receptacle indicates that it is full or close to full.

When full or on another schedule, authorized personnel may then be allowed access to the receptacle to service the receptacle. Access to the receptacle may be granted by one, or a combination of key card(s) key code(s) RFID codes, a mechanical key or the like. The security module or a device carried by the service personnel, may monitor all access including the date, time and operator. The security module may monitor an access code and associate it with a timestamp. This date may be reported to the central office in real time or stored in memory for later use.

Access devices may be issued and controlled. In other words, each access device, whether a key, a key card, an access card, an RFID card or any other type of access device may be issued to a particular person and a record of each issuance may be maintained. A comprehensive profile may be built of each unit, each person, each company, each agency, and each organization that is issued these access devices. When the security module or each lock records each time that a particular access device is used. This data may then be added to the profile. As such, when access is granted by the use of an issued device, the person and entity that accessed the unit may be recorded at the time and date of access.

A variety of different security configurations may be used, depending on the application. For example, two access or confirmation devices may be required in order to open the access door for additional security. In addition, access devices may automatically be changed periodically or at random times for increased security.

When a receptacle is serviced, the movement of the access door 103 and even the movement of the container may be detected or measured. If the bottom of the interior chamber is equipped with a scale, then the amount collected or removed from the collection unit may be measured and recorded. The may be done by measuring height, weight, density, or in using any other suitable measure or combination of measures. This information may be used for security purposes as well as for billing purposes.

Having determined this information, it may be used to tag the container or container liner. Any information or data collected may be used to tag the container or liner, including information to identify the receptacle, the types of materials that may be deposited in it and its location. The tagging may be accomplished by markings or labels that may be machine readable or machine detectable using a bar code, an RFID tag reader, or any other similar device. The markings or labels may also or alternatively be human readable. They may be imbedded, attached, adhered, or within the material matrix of the container itself.

The tag may be generated by the security module or by equipment carried by service personnel. It may use information only obtained using the service equipment or it may also include information stored and generated by the security module. For example, the service personnel may carry a wireless reader that obtains identity, security, and other information from the receptacle's security module and then combines that information with date, time, and identification information about the service event and the servicing agent or agency. This may then be consolidated onto the marking or tag that is then applied to the container or its removable liner.

Tagging the container or liner may also serve as a sealing process for the container. By sealing the container or the removable liner at the time that it is removed from the receptacle, later tampering can be detected. This may be used to prevent or limit theft or unauthorized disposal of the deposited materials.

There are a variety of different ways to seal the container. In one example, one or more large plastic labels may be placed over a lid or a seam, so that the container cannot be opened without disturbing the label. In the example of the 5 gallon bucket above and shown in the figures, an adhesive label may be place over the top and down one or two sides of the bucket after the lid is attached. These large labels could also contain the RFID tag, bar code or other tracking and identification device. In another example, bucket has holes on the side that are aligned with the lid when the lid is in place. One or more loops, ties or plastic seals are then locked in place through the holes so that they go through both the lid and bucket. The loops or ties are configured so that the lid and the bucket cannot be moved without breaking the loop. By placing at least two ties into the closed lid and bucket, one on each side, any attempt to open the lid can be observed.

The service and container information may also be uploaded to a central location where it may be monitored and tracked at all times. The advantage to this type of monitoring is that it helps prevent tampering, loss, or damage to containers in transit or awaiting disposition or destruction of the contents. Container monitoring and tracking also provides or aids in providing a chain of custody that may be required for certain types of collected items.

To provide additional chain of custody information and security, the containers may be monitored during transit. For example, each container may be scanned or detected in another way at certain points during their transit to the ultimate destination. At each point, the containers may be checked for possible tampering.

The containers may again be scanned or detected at the ultimate location to once again determine if there is any possible tampering, since the time at which they were originally picked up from the receptacle. In each instance, tampering may be checked for by comparing height, weight, density, or some other measure, to the initial measurement made at the time the container was originally removed from the receptacle. Seals may also be checked for tampering.

The approach mentioned above is particularly suitable for the example above of collection, transportation, monitoring and safe destruction of unwanted pharmaceuticals and other items that may be harmful to the environment or dangerous when misused.

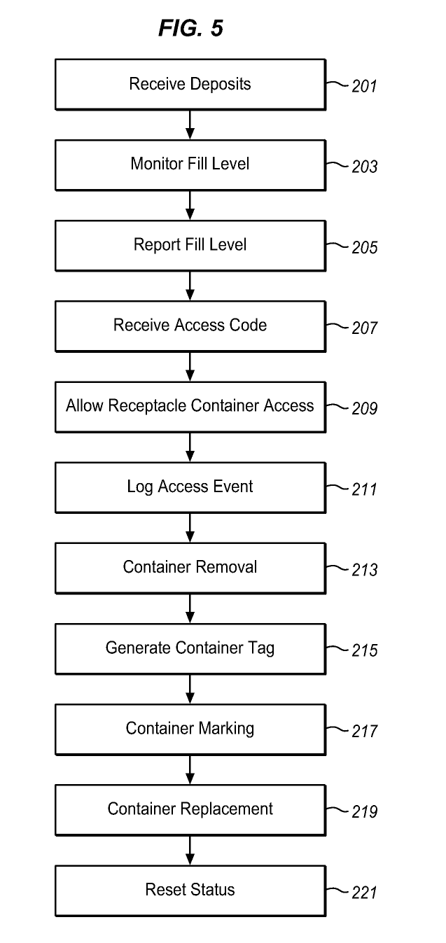

FIG. 5 provides an example process for ensuring a safe, secure, and convenient disposal of hazardous, or dangerous materials. In FIG. 5, at block 201, items are deposited in the collection station. As mentioned above, the receptacle may be positioned at any location or facility where potentially hazardous or dangerous materials may be deposited. At a hospital, pharmacy, clinic, care center, laboratory or other location. The deposited items, may be drugs, medications, chemicals, or disposable materials, such as gloves, covers, syringes, bottles, or other equipment. With the receptacle conveniently located and well marked, it provides a safe, secure and convenient place to dispose of such items.

As items are deposited in the collection station, the fill level is monitored at block 203 and the fill level is reported at block 205. This may be done in different ways, depending on the application. In one example, on-site staff check a window in the access door. When the container inside appears to be full, then a staff member calls a service agency to come and service the container. In another example, the receptacle includes one or more sensors which it uses to monitor the fill level by height, weight, density or some other means. When the container is ready for servicing, or at some time before, the receptacle activates an indicator. The indicator is observed by a staff member who calls the service agency. In another example, the receptacle uses a wired or wireless communications interface to send a message to the service agency when the receptacle is full or close to full.

When the service agency arrives, the service staff will obtain access to the receptacle. In the example of FIG. 5, this is done by sending one or more access codes to the receptacle. These are received by the receptacle at block 207. The codes are checked and if they are valid, then the receptacle grants access to the container inside the receptacle at block 209. This may be done by releasing a lock, moving a mechanical obstacle, or permitting a latch to operate, among other ways.

The receptacle may then log the access event at block 211. The log may be stored in a security module within the receptacle or even in equipment operated by the service agency. The log may contain an identification of the receptacle, the access codes used and a timestamp with date, and time. It may also contain additional information, if that information is available to the receptacle, such as the fill level of the container at the time of access, the nature of the deposited items, a timestamp for the last access and container service, environmental conditions, etc.

After the receptacle container has been accessed, it may be removed or emptied at block 213. In the example of a removable liner, the liner may be removed and replaced and the container left in place. In the example of a removable container with or without a secure lid, the container may be entirely removed and taken away for disposal. The container or liner may then be replaced with an empty one at block 219 that is suitable for the intended purpose.

At block 215, a container tag is generated and at block 217 the container is marked. This may occur before the container is removed from the receptacle or after the container is removed. In one example, the receptacle generates a marker and applies it to the container while the container is in place inside the receptacle. This may be done by programming a memory of an RFID tag, by writing to a magnetic stripe, or any other way of recording data on the container may be used. It may also be done by printing an optical label and applying it to the container.

In another example, the service agency has tools that read data from the receptacle's security module and then generate a tag that the service agent can apply to the container, or to the liner, or both. The security module information may be read with a wired or a wireless connection to the security module. So, for example, the service agent may bring a battery-powered portable printer to the receptacle location. Upon accessing the receptacle, the container is removed and sealed. The printer is then coupled to the security module to download all logged data and identity information into the printer. The printer then prints a label that the service agent attaches to the removed and sealed container. A new container is placed into the receptacle and the service agent takes the container to a vehicle for shipment.

After the receptacle is serviced, its status may be reset at block 221. For example, the fill monitor may be reset, so that the height, weight, or density of the container is associated with a zero fill level. A service timer may be reset, the access code and lock status may be reset, etc. If the security module is capable of external communication, it may then report the access codes and a timestamp for the container service. Any additional information may also be logged and reported. For example, if the service agency uses any communications tools, an identification of those tools may be logged and reported. This information may be used to track the progress of a service agent and to determine if any unauthorized accesses have occurred, using lost, stolen, or unauthorized service equipment.

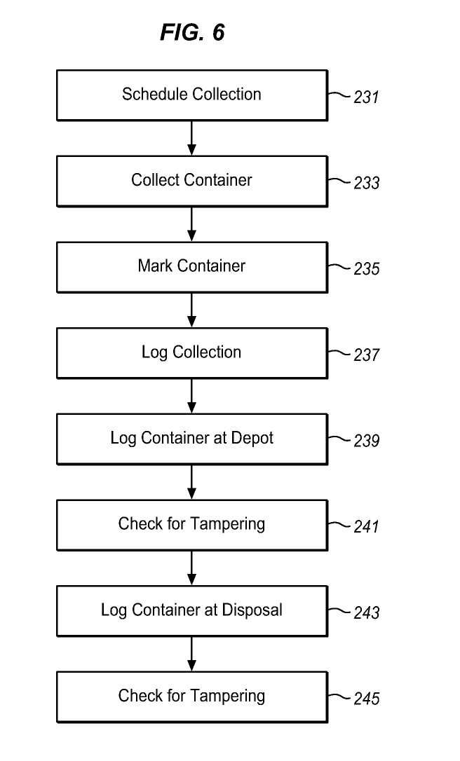

FIG. 6 shows an example of maintaining a receptacle from the perspective of the service agency. In FIG. 6, the service agency begins at block 231 by scheduling a collection from the receptacle. This may be done in response to a call from staff at the facility in which the receptacle is located, in response to a call from the receptacle itself, indicating a particular status, or it may be based on a calendar schedule. While the example of FIG. 6 is related to a full container in the receptacle, the receptacle may also be serviced when it is not full. Service may appear due to normal repair or maintenance or to remove unique materials that require special attention.

At block 233, the container is collected. This is described in more detail with respect to FIG. 5. The container is marked at block 235 also as described with respect to FIG. 5. The collection may then be logged. This may include logging the collection at the receptacle as described above, and may further include logging the collection at the service agency at block 237. The collection may be logged directly by a service agent when the collection occurs or automatically using a tool that that the service agent brings to the collection site. The receptacle may also or alternatively send a log to the service agency.

Having logged the collection, the container with the deposited materials may be transported. The container may be taken to any of a variety of different facilities for disposal or destruction. With some types of deposited materials, it may be possible for the material to be reused or recycled. For example, if the receptacle is used as a drop station for latex surgical gloves and tubing, then it may be possible to recycle the latex material into new gloves or into other products. If the receptacle is used as a drug return drop, then the deposited drugs will likely be destroyed in a secure facility.

During transportation, the containers may be warehoused, temporarily stored, combined, inventoried, or processed in a variety of different ways. At each station along the way, the tag on each container may be read or scanned and logged, block 239. If the container tag contains information about weight, density, fill level or another measurable parameter, then the measurement may be repeated and compared with the tag information. The seals on the container may also be checked. This allows each container to be checked for tampering, block 241, at each depot at which it stops. Not only may its location be recorded, but also its status. If tampering is discovered, the data for all the containers may be compared to determine systematic threats as compared to individual handling errors.

At the final disposal station, the arrival of the containers may also be logged at block 243, and a final check for tampering may be performed at block 245. The presence of tag reading stations at each point along the way to the disposal site allows for the complete chain of custody to be established for each container. So for example, one group of service agents may collect full containers from receptacles and bring them back to the service agency. Another group may load these containers onto larger trucks to take them to different locations, depending on the nature of the deposited materials inside. The trucks may then deposit the containers with a disposal agency for the particular material. The disposal agency may then transport the containers to a central disposal facility at which the materials are finally disposed of. At each of these locations, the location and status of each container may be logged. This allows the entire disposal path to be monitored and secured.

As mentioned above, the user deposits materials in the receptacle for later pickup. by a maintenance or service organization. The user experience can be improved and made more secure in a variety of different ways. The receptacles may be augmented to enhance the user experience. In addition, the receptacles may be augmented to control the types of materials that are deposited and to obtain information about those materials. The security module 145 may be enhanced to provide additional functionality or a different, separate, or additional system may be used.

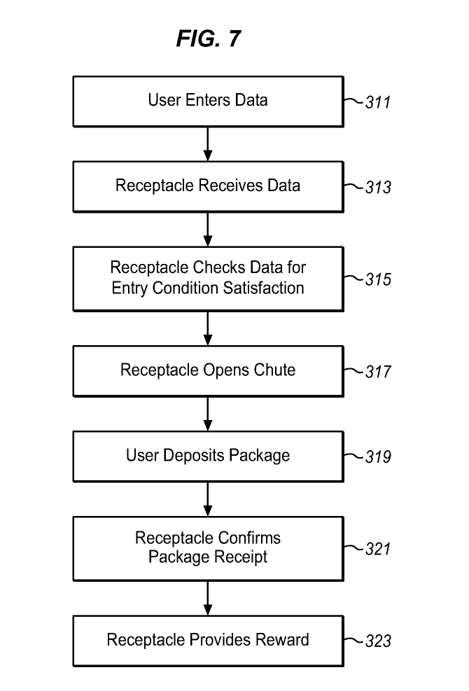

FIG. 7 is a generalized process flow diagram for using an enhanced receptacle in one example. The operations will be described in the context of a receptacle equipped with an enhanced security module. This module will be referred to as a controller for purposes of the present discussion. This controller includes a user interface that allows for data entry and display, sensors, and actuators to sense and control access to the drop chute opening 111, as well as communications facilities such as those described for the security module earlier. The controller does not need to include any more features and parts than what is necessary to perform the specific functions of any one particular process described herein. Accordingly, the specific design of the controller may vary with different applications.

Starting with FIG. 7, at 311, the user enters data into an interface part of the receptacle. This can by electrical, magnetic, radio, or optical scanning. It can also be done manually by the user. The data can identify the user, the item to be deposited, subscription data, authorization data, or any of a variety of other types of information. At 313, the receptacle receives the data and stores it at least temporarily to associate with the deposit. At 315, the receptacle checks the data that it has received to determine whether its conditions for that entered data have been satisfied. These conditions may relate to the type of item, the identity of the user, payment or subscription conditions, time of day or time expiration and other conditions, depending on the particular application.

At 317, if the conditions have been satisfied, then the controller allows access to the receptacle. The user can then deposit the package at 319 through the access chute opening 111. The receptacle shown, for example, in FIG. 1 above can be modified with access controls that are driven by electrical actuators, for example. In one example, the access door opens when the conditions have been met to allow the user to insert the package.

At 321, the receptacle confirms that it has received the package. This can be done using the scale mentioned above, or any of a variety of other sensors. Access to the chute can then be closed and at 323, the user is provided with some sort of reward. This may be a simple receipt or it may be a promotional or payment item. In one embodiment, the user is provided with a tracking number that can be used later to track the progress of the package.

With the receipt of information and the confirmation of receipt, the receptacle can generate a log of received items. In addition to a weight or volume measurement, described above, the receptacle can keep a record of the number of items deposited and may even be able to record the nature of each item. If UPC or RFID codes are received for each item, the receptacle can keep a record that specifically identifies each item deposited by make, product, size, etc. Depending upon the information provided by each user, the receptacle can also or alternatively keep a record of all of the users of the receptacle and what they have deposited.

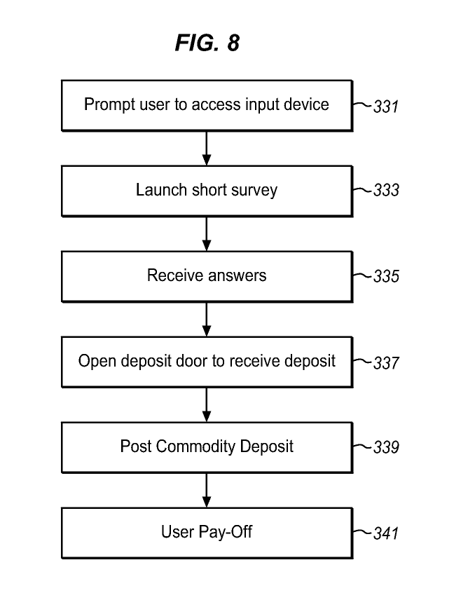

The process flow of FIG. 7 may be better understood in light of the specific examples of FIGS. 8, 9, and 10. Features and details of any one of FIGS. 8, 9, and 10 may be applied to any of the others, depending on the particular application.

Referring to the example of FIG. 8, the controller is equipped with a user input device, such as a keyboard or a touch screen and a display or speaker to provide instructions or prompts to the user. Beginning at 331, the user is asked to access the input device, such as a keyboard, trackball or touch screen. In another embodiment, a voice command interface may be used to interpret speech and respond with audio prompts and instructions. Having received an acknowledgment from the user, the system may begin with a series of data requests at 333 and receive answers to the requests at 335. These requests may relate to identifying the user, identifying the package to be deposited, and other topics.

In one example, the survey presents questions directed to the desires of the user. These may include questions such as, “why are you returning this item?” “why are you disposing of this item?” “is this item being replaced by another item?” “If so, why?” Such questions can be used for marketing, product improvement, and for quality control, etc. In addition, the user may be asked to identify or describe the nature of the item to be deposited so that it can be properly handled. By providing this information, product stewardship can be improved. The user may be allowed to answer using a multiple choice format, such as a) expired, b) old or c) not needed and disposing the environmentally correct way. Alternatively, the user may be guided through levels of answers using a decision tree so that the questions are presented as simply as possible and only relevant questions are asked. A variety of different questions can be asked.

At 337, if the answers have been received and are accepted, then the user can be granted access to the access chute to deposit the package. After the user deposits the item, then the deposit can be posted at 339. At 341, the user is then provided with some item of value, such as a reward. The reward can be some form of pay-off or a take away Item. In one example, the user is prompted to remove an instant rebate coupon from the unit's on board printer. As an example, an instant rebate or a coupon for a new purchase can be provided. This coupon or instant rebate may be used to purchase items, products, or services from the establishment where the collection unit is located or from another sponsored or associated establishment. This can be in the form of printed paper, printed or magnetically encoded plastic, a plastic card featuring RFID technology or in the form of a gift card or the like.

Consider a more specific example in which a user may use the receptacle to dispose of a prescription or non-prescription drug. The survey may ask questions about the drug, about the user's experience with the drug and its effectiveness. This information can then be submitted to the drug manufacturer to aid in product or marketing improvements that may improve the user's experience. The pay off can be a coupon or advise on a different drug that is intended to treat similar symptoms, but that has different side effects or interactions.

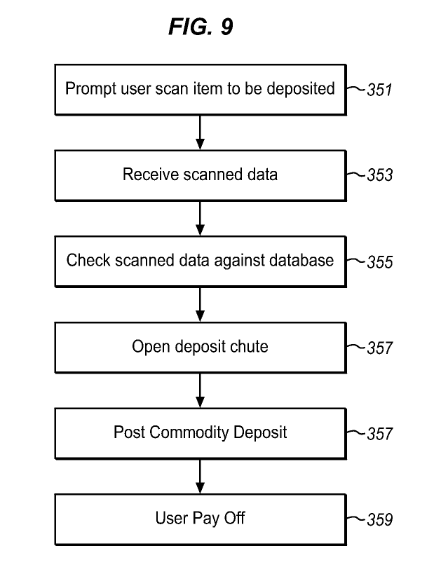

FIG. 9 shows an alternative process flow for the enhanced receptacle. In the example of FIG. 9, at block 351, a user is prompted to bring the item to be deposited to a scanner that is coupled to the receptacle. The scanner may be an optical scanner to read a UPC (Universal Product Code), bar code, or other optically readable code. Alternatively, the scanner may be an RFID reader or another type of electrical, magnetic, or optical reader.

At block 353, the receptacle receives the scanned data from the product to be deposited. At block 355, the data is checked against a database to ensure that it satisfies the conditions for use of the receptacle and if so then at 357, the access door is opened to receive the deposit. In one example, the data captured from the scanner or the reader is recognized from a database confirming that this item is in fact intended to be collected by this collection unit. This operation minimizes any comingling of unwanted, forbidden or dissimilar items. If the item is not intended to be collected, then the users item is rejected and the access door is not opened. Capturing scanned data from the commodity to be deposited is also valuable from a marketing, use and product stewardship basis.

If the user deposits the item, then that deposit is posted and the user receives a pay-off. This pay off can be similar to the pay off described above with respect to FIG. 8.

Consider a particular example in which a user wishes to dispose of a hard disk drive that contains personal, confidential, or sensitive information. Hard disk drives typically are labeled with a UPC that identifies the manufacturer, product name, drive capacity, and form factor. It may also be possible to read or scan a product serial number. The UPC can be checked against a database to obtain this information and the information can be logged at the receptacle. After the user deposits the drive, he can be provided with a receipt that can be used to prove that the drive has been disposed of.

In an organizational environment, the receipts can be used by employees as verification that they have deposited the drive responsibly and conformed to organizational policies. The receptacle can also require the user to provide a personal identification, such as a name, or employee identification. This can be used to link deposits with specific individuals and even with time and date information. The wealth of collected information provides for strong confirmation of compliance with organizational policies.

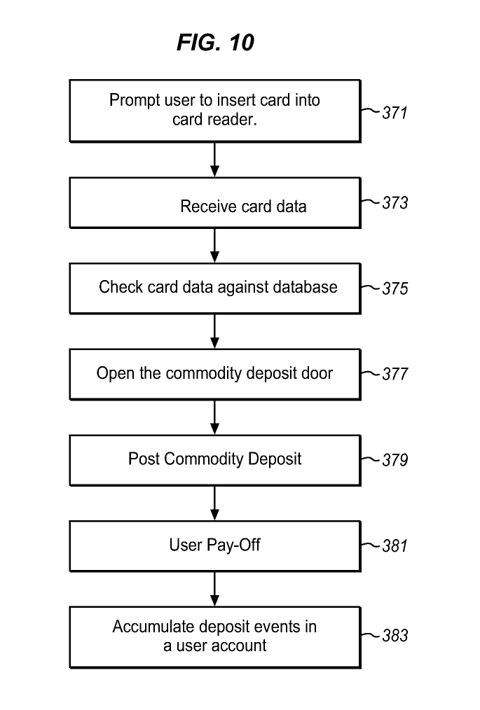

FIG. 10 show another use example for an enhanced receptacle with a controller. In FIG. 10, the user is prompted to insert a card into a card reader, such as a gift card. At 373, the data is read from the gift card and at 375, the card data is checked against a database. In this example, the data captured from the gift card may be used for is marketing, product use studies, and product stewardship analysis. After receiving the gift card data, at 377, the deposit door is opened and at 379, the user's deposit is received and posted.

Having posted the deposit, the receptacle provides the user with an incentive or reward at 381. In one example, the user is prompted to remove a deposit event receipt from the unit's on board printer. This receipt may contain a unique numerical or machine readable code that may be used to receive a “certificate” or a “confirmation” that the deposited commodity has been disposed of or recycled in an environmentally responsible way. It may also inform the user of various promotions on related items that may be occurring at the facility. At 381, deposit events are accumulated in a user account related to the gift card. Deposit events may also accumulate as membership reward points to be redeemed, gifted, donated, etc. The accumulation may happen by sending data to a central database or it may be accumulated by writing the new account balance onto the gift card. By writing the new balance onto the gift card, there is no need to maintain a balance in an external database and the user may use the card in any compatible reader. The receptacle may also print a receipt advising the user of the new balance and any rights or privileges that may ensue as a result.

The processes described above may be applied to many different types of items, such items may include, for example, environmentally sensitive items, such as drugs, sharps, lancets, electronics, CFL's ((compact florescent lamps)), batteries, plastics, etc. Alternatively, the items may contain sensitive information, such as documents, magnetic storage drives, electronic memory, optical discs, bank or payment account cards, membership cards or certificates, etc. In each case, using the processes described above, the user is assured that the item is disposed of properly and the user is provided with a confirmation or incentive for the disposal.

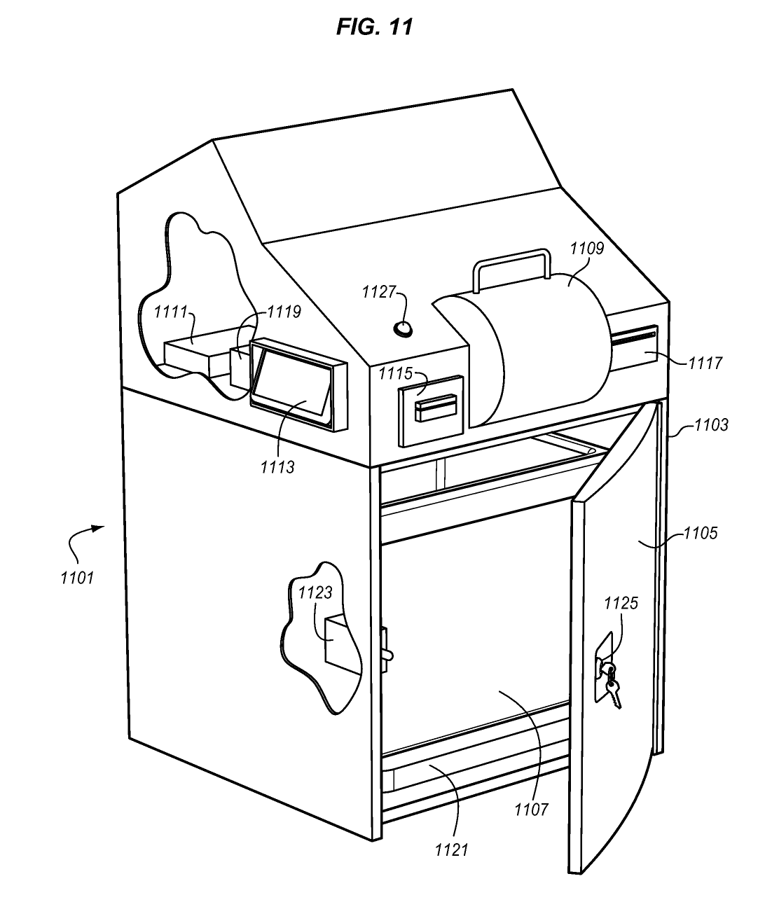

FIG. 11 shows an example of an enhanced security module in the context of a receptacle as described above. The collection unit 1101, includes an exterior housing 1103, with a front access door 1105 to allow access to the container 1107 inside to maintain the collection unit. A deposit chute door 1109 near the top of the collection unit allows users to deposit items into the container inside. The smart collection unit includes a computer 1111 inside the housing to maintain and monitor the functions of the receptacle and provide the various functions described above. The computer may be based on a PC-type architecture, a simpler embedded system architecture or any other desired architecture and operating system. The computer includes a processor or controller, a memory to store instructions and data, and interfaces to the other components described below. The memory may be a single solid state non-volatile memory or there may be multiple types of memory for storing different types of information.

The computer 1111 is coupled to a touch screen mounted to the exterior of the housing to display results and receive user input. The screen can indicate instructions, measured weights, and transaction status. In addition, it can be used to allow users to enter personal information and preferences. The computer is also coupled to a card reader 1115 mounted to the exterior of the housing to allow gift cards and identification cards to be read and written to. In addition, the card reader can be used to authorize service personnel to access the front door. The computer is also coupled to a printer 1117 mounted to the exterior of the housing to print receipts, coupons, status reports, and other items.

Internally, the computer 1111 is coupled to an internal radio system 1119 to allow communication with RFID devices and wireless networks. The radio system may also be configured to connect to portable service personnel equipment through a personal area network or other radio link, to report status and condition and receive settings and instruction wirelessly. A wired interface (not shown) may also be provided to allow for wired network and wired service access.

The computer is also coupled to a scale 1121 under the container inside the housing for detecting deposits and reporting weights to the user and service personnel as described above. The computer is further coupled to a deadbolt actuator 1123 to lock and unlock the access door. While the access door has a key 1125 for further security the computer controlled deadbolt can prevent the door from being opened until access permission is verified. A service person can provide access by swiping using an access card through the card reader, entering a specific code on the touchscreen, or sending an authorization code through the radio system. The deadbolt is then released by the computer so that the door can be opened allowing access to the container. The deadbolt actuator can also include access door position sensors, either mechanical or infrared, to indicate to the computer whether the door is opened or closed and to prevent the deadbolt from actuating unless the access door is fully closed.

The computer is also coupled to an LED display 1127 in the form of one or more status lights. The computer drives these lights to provide the indications described above. Alternatively, the function of the LED display may be provided by the touch screen.

The smart collection unit 1101 may be modified in the position of the illustrated components as well as the particular components used. Some of the components may be removed and others may be added to better suit particular function and user desires. The particular locations of the features and the choice of included features is provided only as an example.

A lesser or more complex collection unit, funnel system, sorting system, access door, locking mechanism, fill level monitoring device and communications devices may be used than those shown and described herein. Therefore, the configurations may vary from implementation to implementation depending upon numerous factors, such as price constraints, performance requirements, technological improvements, or other circumstances. Embodiments of the invention may also be applied to other types of deposits that use different types of materials, scheduling and disposal methods than those shown and described herein.

While the embodiments of the invention have been described in the context of returning drugs, similar depositories may be used for different applications. Also different inventory and tracking methods and technologies may be adapted to suit different types of deposited items.

In the description above, numerous specific details are set forth. However, it is understood that embodiments of the invention may be practiced without these specific details. For example, well-known equivalent circuits, components, assemblies and configurations may be substituted in place of those described herein, and similarly, well-known equivalent techniques, processes, and protocols may be substituted in place of the particular techniques described. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. An apparatus comprising:
an exterior housing;
a drop chute in the housing to receive materials;
a removable storage container to receive the materials from the drop chute;
a user interface to receive information from a user; and
a controller to receive the information from the user and to conditionally allow access to the drop chute based on the received information

2. The apparatus of claim 1, further comprising a drop chute door to prevent and allow access to the drop chute and wherein the controller is coupled to the drop chute door to open and close the door to conditionally allow access to the drop chute.

3. The apparatus of claim 1, wherein the user interface comprises a user input device and a display and wherein the information is received from the user in the form of answers to a survey.

4. The apparatus of claim 1, wherein the user interface comprises an item code scanner to read item information scanned from the item.

5. The apparatus of claim 1, wherein the user interface comprises a card reader and wherein the received information comprises information read from a card.

6. The apparatus of claim 5, wherein the card is a gift card.

7. The apparatus of claim 5, further comprising a card writer and wherein, upon receiving an item in the drop chute the controller causes the card writer to write information on the card.

8. The apparatus of claim 1, further comprising a printer coupled to the controller to print a receipt for the user upon receiving an item in the drop chute.

9. The apparatus of claim 8, wherein the receipt includes a reward to the user.

10. The apparatus of claim 8, further comprising a sensor to determine whether an item has been deposited to the drop chute and wherein the controller is coupled to the sensor to print a receipt only if the sensor determines that an item has been deposited.

11. The apparatus of claim 1, further comprising a communications interface coupled to the controller and wherein the controller is further to check the received information against a remote database for satisfaction of a condition and wherein the controller allows access to the drop chute only upon satisfaction of the condition.

12. A method comprising:
receiving data entered by a user;
checking the data for satisfaction of an entry condition;
allowing access to a drop chute of a secured storage receptacle if the data satisfies the entry condition;
determining whether an item is deposited in the drop chute; and
providing a reward to the user if an item has been deposited in the drop chute.

13. The method of claim 12, wherein receiving data comprises receiving answers to survey questions, wherein the survey questions are presented to the user.

14. The method of claim 12, wherein receiving data comprises scanning a code of an item to be deposited.

15. The method of claim 12, wherein checking the data comprises checking the data against a local database.

16. The method of claim 12, wherein checking the data comprises sending the data to a remote server and receiving a response from the remote server.

17. The method of claim 12, wherein providing a reward comprises printing a receipt to provide to the user.

18. The method of claim 12, wherein providing a reward comprises providing a promotional reward for new purchases.
